(19) United States
(12) Patent Application Publication
(10) Pub. No.: US 2024/0427531 A1
(43) Pub. Date: Dec. 26, 2024

(54) IMAGE PROCESSING APPARATUS, METHOD FOR CONTROLLING IMAGE PROCESSING APPARATUS, AND STORAGE MEDIUM

(71) Applicant: CANON KABUSHIKI KAISHA, Tokyo (JP)

(72) Inventor: Hinako Ishii, Tokyo (JP)

(21) Appl. No.: 18/748,399

(22) Filed: Jun. 20, 2024

(30) Foreign Application Priority Data
Jun. 26, 2023 (JP) 2023-104094

(51) Int. Cl. G06F 3/12; H04N 1/00

(52) U.S. Cl. CPC G06F 3/1204; G06F 3/1205; G06F 3/1258; H04N 1/00729

(57) ABSTRACT

An image processing apparatus includes an identification unit that identifies a sheet size and a sheet type of an adjustment target sheet, a display control unit that, in a case of making an adjustment of a setting value of the sheet type automatically based on the sheet size and the sheet type identified by the identification unit, displays on a display unit an operating procedure for making the adjustment automatically, and a setting unit that sets the sheet size and the sheet type after the adjustment for a paper feed source into which the adjustment target sheet is loaded.

### BACKGROUND

### Field

The present disclosure relates to an image processing apparatus, a method for controlling the image processing apparatus, and a storage medium.

### Description of the Related Art

The quality of a printed image produced by an image processing apparatus is greatly dependent on whether the properties of the image processing apparatus (such as, for example, properties pertaining to conveyance, transfer, and fixation) and the properties of a sheet (such as a sheet type or a basis weight) conform to each other.

Japanese Patent Laid-Open No. 2002-029120 discloses an image processing apparatus having a function to register sheet types with user-customized setting values into a database and a function to select any of the sheet types from the database and set it as a type of the sheet fed to a paper feed source.

### SUMMARY

However, the prior art has a plurality of means for changing the settings values, and the user needs to select a changing means for each of the setting values. Then, using the changing means selected, the user is required to make adjustments of setting values so that they may be suitable for printing the target sheet. It is presumably difficult for a normal user to make sophisticated adjustments of setting values for high-quality printing.

An image processing apparatus according to one aspect of the present disclosure includes an identification unit that identifies a sheet size and a sheet type of an adjustment target sheet, a display control unit that, in a case of making an adjustment of a setting value of the sheet type automatically based on the sheet size and the sheet type identified by the identification unit, displays on a display unit an operating procedure for making the adjustment automatically, and a setting unit that sets the sheet size and the sheet type after the adjustment for a paper feed source into which the adjustment target sheet is loaded.

Further features of the present invention will become apparent from the following description of exemplary embodiments with reference to the attached drawings.

### BRIEF DESCRIPTION OF THE DRAWINGS

FIG. 1 is a block diagram showing an example configuration of an image processing apparatus;

FIG. 2 is a block diagram showing an example detailed configuration of a control device of the image processing apparatus;

FIG. 3 is a diagram showing an example of processing functions of the image processing apparatus;

FIG. 4 is a diagram showing an example of a media sensor of the image processing apparatus;

FIGS. 5A to 5H are diagrams showing example operation screens;

FIGS. 6A to 6C are diagrams showing example operation screens; and

FIG. 7 is a diagram showing the relationship of FIGS. 7A and 7B; FIGS. 7A and 7B are flowcharts showing an example of processing to register sheet information.

### DESCRIPTION OF THE EMBODIMENTS

### Embodiment 1

An embodiment of the present disclosure is described below based on the drawings.

### <Configuration of an Image Processing Apparatus>

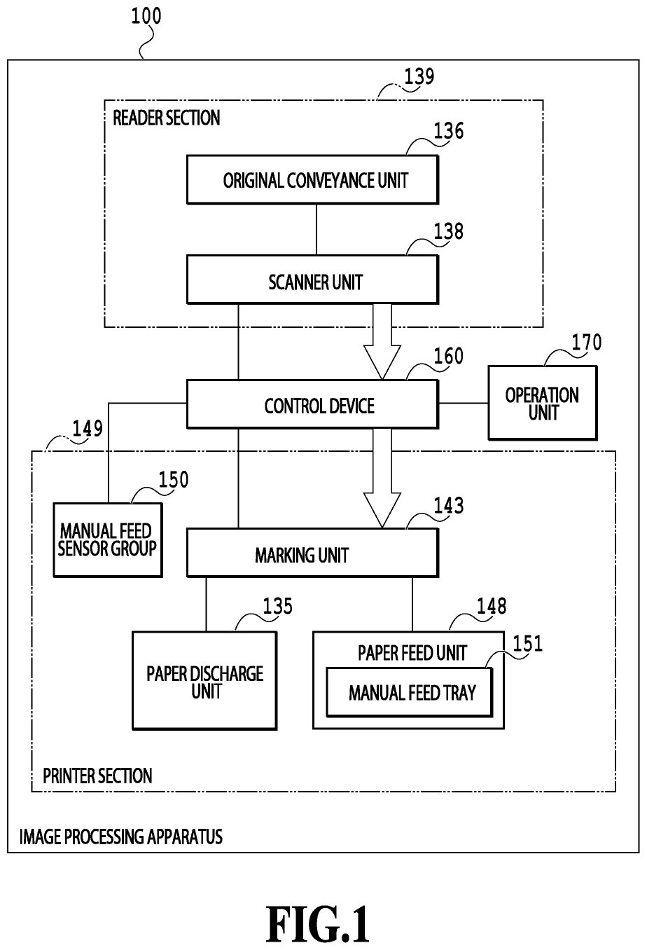

FIG. 1 is a block diagram showing the configuration of an image processing apparatus according to the present embodiment. As shown in FIG. 1, an image processing apparatus 100 includes a reader section 139, a printer section 149, a control device 160, and an operation unit 170.

The reader section 139 has an original conveyance unit 136 for conveying an original and a scanner unit 138 for reading an image on an original conveyed from the original conveyance unit 136. Image data obtained by the scanner unit 138 is inputted to the control device 160. The scanner unit 138 can also read an image on an original without the original conveyance unit 136 being involved.

The printer section 149 has a paper feed unit 148, a marking unit 143, a paper discharge unit 135, and a manual feed sensor group 150. The paper feed unit 148 has a plurality of cassettes housing print paper of different sizes from each other and a manual feed tray 151 on which a special sheet such as an envelope, an OHP film, or coated paper can be placed, and print paper is fed from one of the cassettes or the manual feed tray 151. The paper feed unit 148 also has a media sensor that detects the surface properties, thickness, or the like of a sheet loaded (set) therein, and the control device 160 determines a sheet type based on the detection result from the media sensor. The marking unit 143 is a unit having an electrophotographic image formation process. In this marking unit 143, an image is formed on print paper fed from the paper feed unit 148 based on image data inputted thereto from the scanner unit 138 via the control device 160. Note that the printing method employed by the printer section 149 in the present embodiment may be the electrophotographic method, the inkjet method, or any other method.

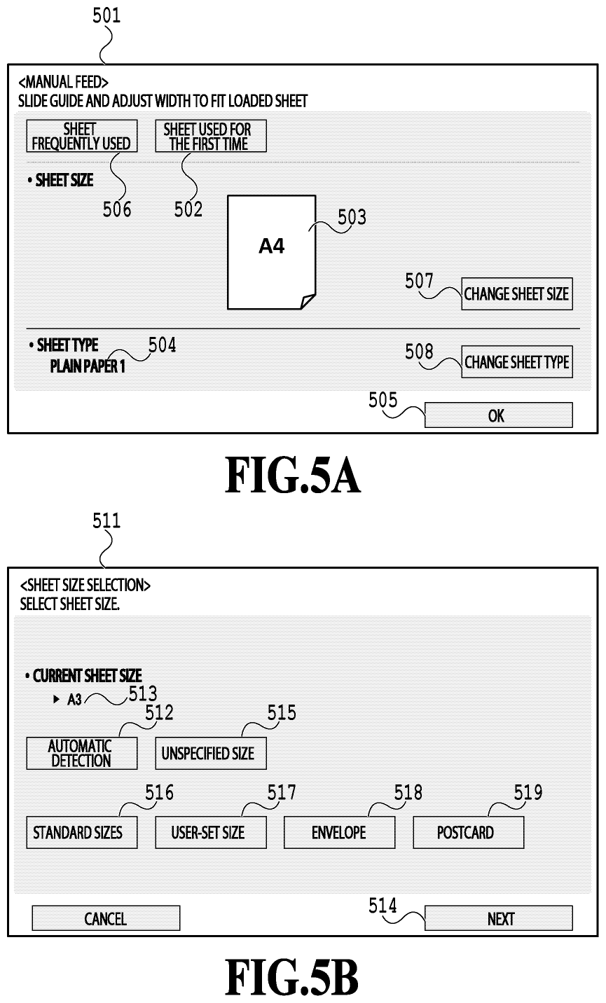

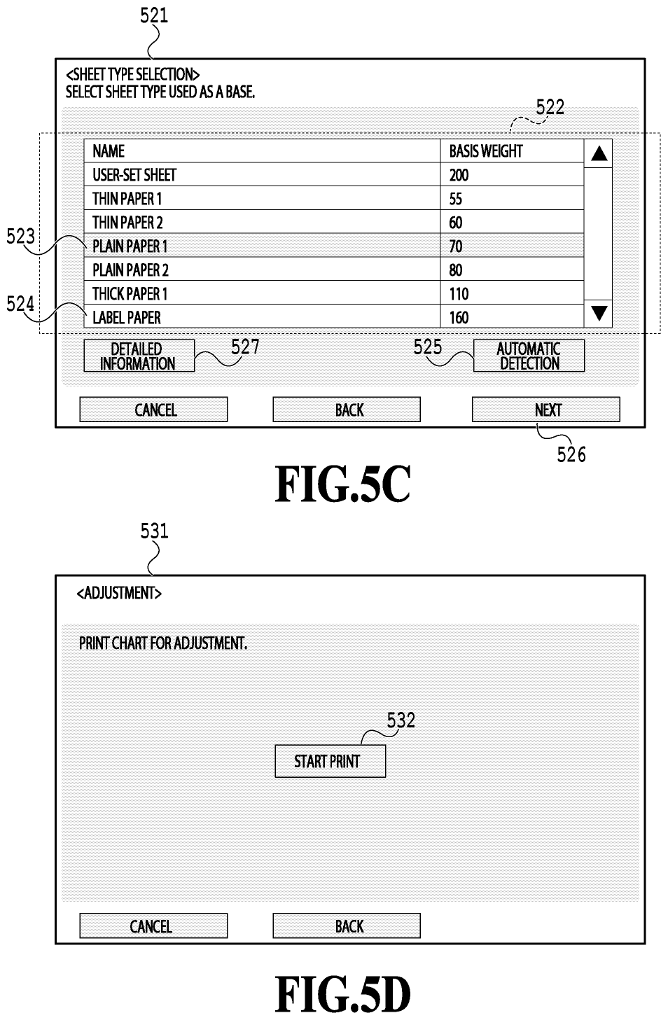

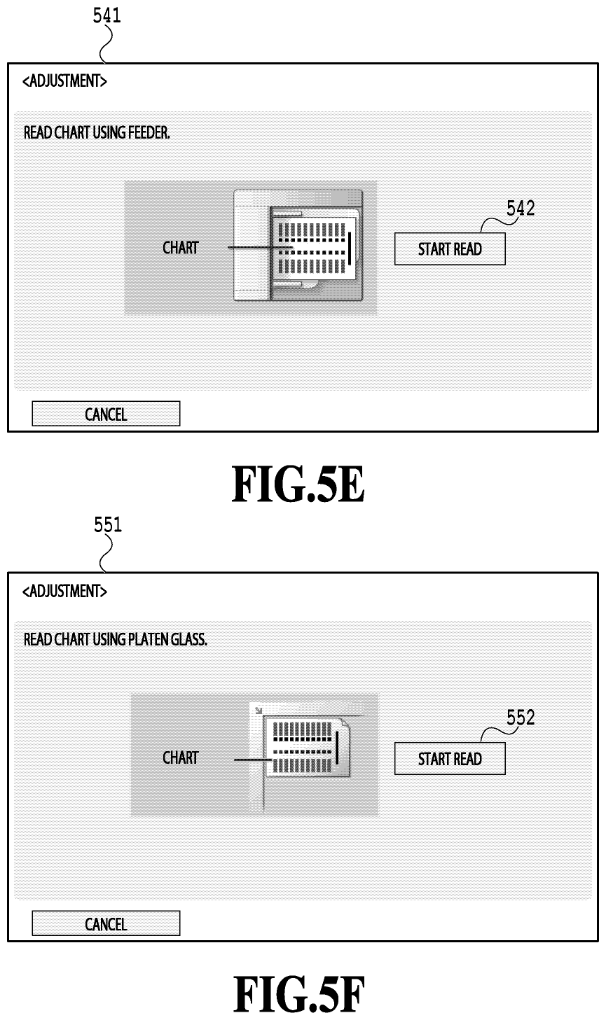

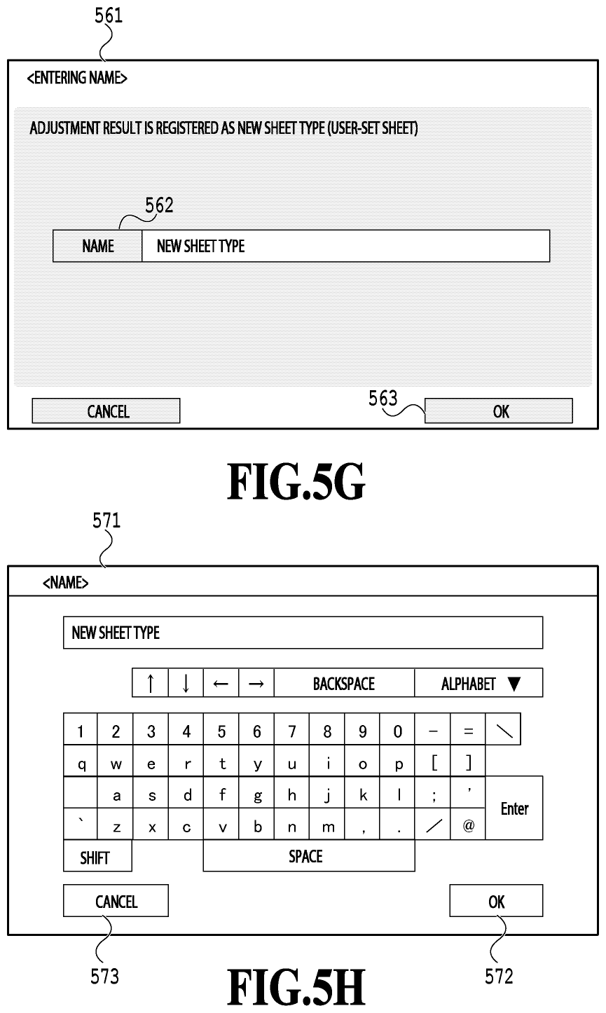

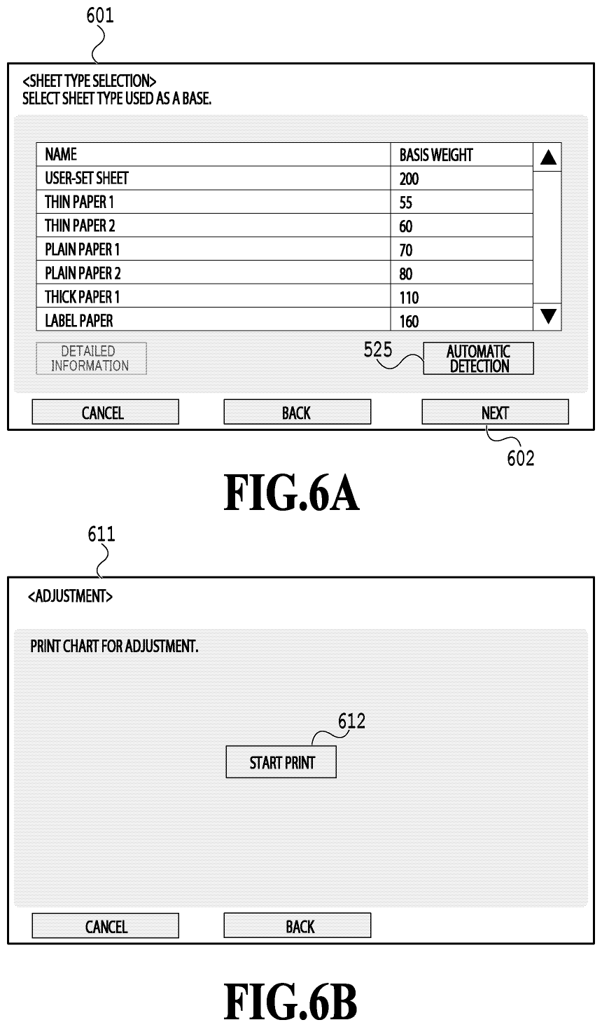

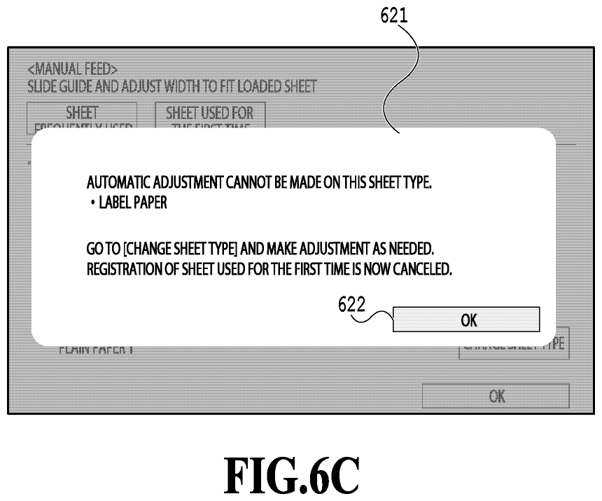

The paper discharge unit 135 discharges print paper on which an image has been formed by the marking unit 143 to the outside of the apparatus after performing processing such as sorting and stapling. The manual feed sensor group 150 is a plurality of sensors provided at the manual feed tray 151. The manual feed sensor group 150 detects the width of the guide at the manual feed tray 151 and also detects whether a sheet is placed on the manual feed tray 151. Once the manual feed sensor group 150 detects that a sheet is placed on the manual feed tray 151, a screen is displayed on the operation unit 170, as will be described later using FIGS. 5A to 6C.

The control device 160 is electrically connected to the reader section 139 and the printer section 149. The control device 160 implements a copy function by performing control as follows: causing the reader section 139 to read an original and obtain image data thereon, outputting the image data to the printer section 149, and causing the printer section 149 to form an image on print paper. The operation unit 170 has various keys used for inputting instructions and the like to the control device 160 and a liquid crystal display panel for displaying interface screens for a user. The operation unit 170 generates a signal corresponding to the key which has been operated and outputs the signal to the control device 160.

### <Detailed Configuration of the Control Device>

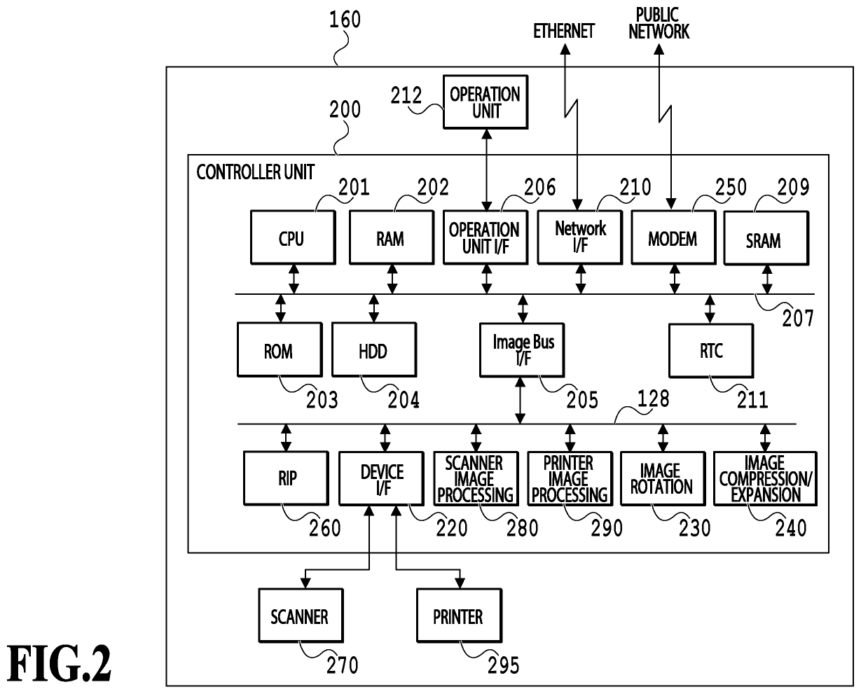

FIG. 2 is a block diagram showing a detailed configuration of the control device 160 according to the present embodiment. A controller unit 200 is connected to a scanner 270, which is an image input device, and a printer 295, which is an image output device, and meanwhile connected to Ethernet (registered trademark) or a public network to input and output image information and device information. A CPU 201 is a controller that controls the image processing apparatus 100. A RAM 202 is system work memory for the CPU 201 to operate and is also image memory for temporarily storing image data. A ROM 203 is a boot ROM and stores a system boot program. An HDD 204 is a hard disk drive and stores system software, applications, and image data.

An operation unit I/F 206 is an interface with the operation unit 212 having the touch panel, and through the operation unit I/F 206, image data to be displayed on the operation unit 212 is outputted to the operation unit 212. The operation unit I/F 206 also plays the role of passing, to the CPU 201, information which has been inputted on the operation unit 212 by a user of the present system. A network I/F 210 is connected to a network and used for input and output of information. A modem 250 is connected to a public network and used for input and output of information.

A SRAM 209 is a nonvolatile storage medium capable of high-speed operation. A RTC 211 is a real-time clock and performs processing to keep counting the current time regardless of whether the controller unit 200 is being supplied with power. The above-described devices are on a system bus 207.

An image bus I/F 205 is a bus bridge that connects the system bus 207 and an image bus 208 for high-speed transfer of image data to each other and converts data structures. The image bus 208 is formed of a PCI bus or IEEE 1394. The following devices are on the image bus 208. A RIP 260 is a raster image processor and develops PDL code into a bitmap image. A device I/F unit 220 connects the scanner 270 or the printer 295, i.e., an input or output device, to the controller unit 200 and performs synchronous/asynchronous conversion of image data. A scanner image processing unit 280 performs correction, touching, or editing of input image data. A printer image processing unit 290 performs printer correction, resolution conversion, or the like on print output image data. An image rotation unit 230 rotates image data. An image compression/expansion unit 240 performs compression/expansion processing.

### Configuration Related to the Present Embodiment

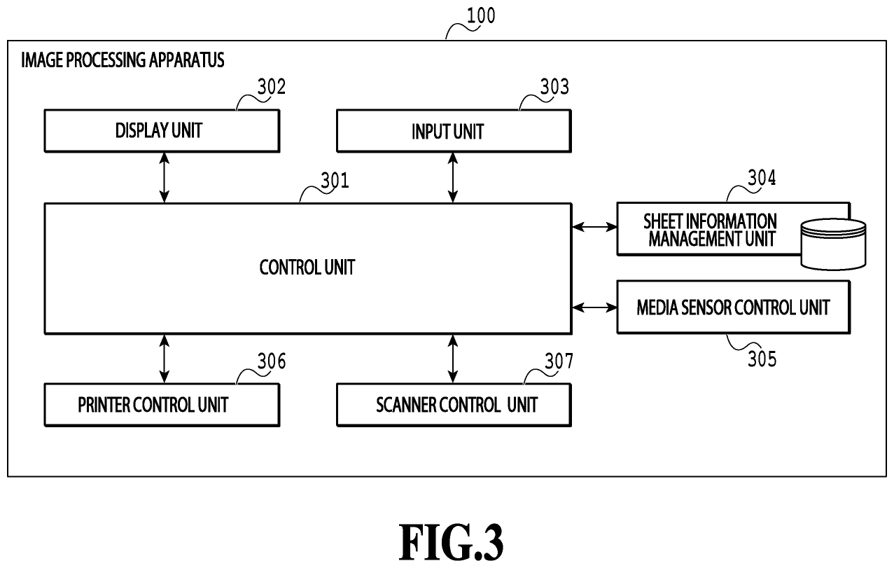

FIG. 3 is a diagram showing an example configuration of processing functions of the image processing apparatus 100 that are related to the present embodiment. As shown in FIG. 3, the image processing apparatus 100 includes a control unit 301, a display unit 302, an input unit 303, a sheet information management unit 304, a media sensor control unit 305, a printer control unit 306, and a scanner control unit 307. As described using FIG. 2, the processing functions described below and processing related to the flowchart to be described later are implemented as follows: based on programs stored in the ROM 203, the CPU 201 executes some or all of the programs on the RAM 202. The display unit 302 is a function to control display of the status of the image processing apparatus 100 or an operation menu on the operation unit 212. The input unit 303 is a function to receive operation instructions from a user. The sheet information management unit 304 is a function to process sheet information and also store sheet information in a database (DB). The media sensor control unit 305 is a function to determine the type of a sheet conveyed from the paper feed unit 148 based on a detection result on the surface properties, thickness, or the like of the sheet. Details will be described later. The printer control unit 306 is a function to issue a print instruction to the device I/F unit 220. The scanner control unit 307 is a function to issue a scan instruction to the device I/F unit 220. The control unit 301 is a function to control the units 302 to 307.

### <Description of the Media Sensor>

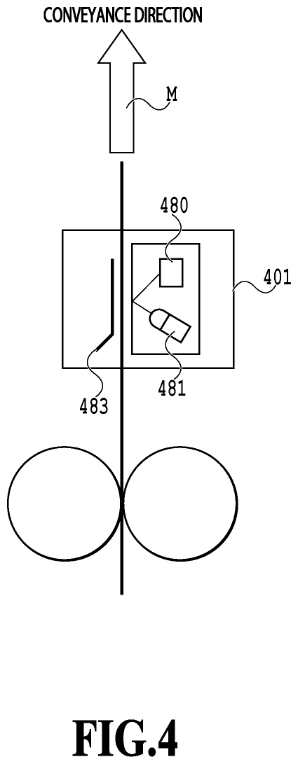

FIG. 4 is a diagram showing an example of the media sensor installed at the paper feed unit 148. As a light-emitting device, a light-emitting diode (LED) 481 is disposed inside a media sensor 401. Also, as a light-receiving device, a photodiode 480 is disposed inside the media sensor 401. The photodiode 480 can detect the amount of reflected light of light emitted by the LED 481. The media sensor 401 is also provided with a guide unit that a sheet M enters. The media sensor control unit 305 receives an input signal from the photodiode 480 as an output value from the media sensor 401. Based on the received value which is different depending on the surface properties or thickness of a sheet, the media sensor control unit 305 can determine the type of the sheet passing through. Then, the media sensor control unit 305 controls the image processing speed or fixation temperature optimally according to the type of the sheet thus detected.

Because the media sensor control unit 305 thus uses the media sensor 401 to determine a sheet type in the present embodiment, a user does not need to set the sheet type intentionally. Thus, the image processing apparatus 100 of the present embodiment has a mode of operation based on print control parameters and the like automatically set based on a sheet type determined by the media sensor 401. Additionally, the image processing apparatus 100 of the present embodiment also has a mode, as in the prior art, of operation based on a sheet type to be used manually set by a user. A user can set which mode to use in advance by operating the input unit 303. Note that the configuration of the media sensor 401 described above is merely an example, and the present embodiment is not limited to this configuration. For example, the media sensor 401 may have a configuration having an ultrasonic sensor such as a piezoelectric device in combination with the light-emitting device and the light-receiving device and may have such other configurations.

### <Processing to Register a User-Set Sheet>

Next, with reference to FIGS. 5A to 7, a description is given of a method for determining an optimal setting value for printing a certain sheet depending on the size and type of the certain sheet, associates the sheet with the setting value, and registers them into a database (DB) as a user-set sheet.

First, FIGS. 5A to 5H are diagrams showing a series of display screens for registering a user-set sheet which are displayed on the operation unit 212 by the image processing apparatus 100. FIG. 5A is a display screen which can be used to manage sheet size 503 or sheet type 504 set for the manual feed tray 151. This display screen is closed upon pressing of an OK button 505. A user can change a setting value for the sheet size 503 on CHANGE SHEET SIZE 507 and change a setting value for the sheet type 504 on CHANGE SHEET TYPE 508. Note that in the present embodiment, a sheet type does not simply indicate the type of a sheet, such as “plain paper” or “film paper,” but also includes a setting value set for the sheet and used for printing. Thus, for plain paper for instance, there are “plain paper 1” and “plain paper 2.” They are both “plain paper” but have different setting values used in printing.

On SHEETS FREQUENTLY USED 506, a plurality of combinations of a sheet size and a setting value of a sheet type can be saved, which enables setting of a sheet size and a sheet type at once.

The processing below applies not only to the manual feed tray 151, but only to any of the plurality of paper feed sources in the paper feed unit 148. In the processing, the input unit 303 detects a user operation and notifies the control unit 301 of a location (coordinates) on the screen which has been pressed. The control unit 301 determines which button was pressed based on the coordinates and the bitmap of the screen being displayed on the operation unit 212, performs processing related to the button, generates a screen to be displayed next, and notifies the display unit 302 of the content of the screen. The display unit 302 displays, on the operation unit 212, the screen of which it has been notified. Processing is thus performed in response to user operations, and the screen changes accordingly.

FIG. 5B is a screen on which to select the size of an adjustment target placed on the manual feed tray 151. FIG. 5B is a screen displayed upon pressing of SHEET USED FOR THE FIRST TIME 502 shown in FIG. 5A. Items related to a sheet size selectable in the present embodiment include AUTOMATIC DETECTION 512, UNSPECIFIED SIZE 515, STANDARD SIZES 516, USER-SET SIZE 517, ENVELOPE 518, AND POSTCARD 519. Upon detection of any of the above buttons being pressed, the selected size is displayed on CURRENT SHEET SIZE 513. Note that the above sheet sizes are merely examples, and there may be other sheet sizes.

AUTOMATIC DETECTION 512 can select a sheet size detected by the manual feed sensor group 150. UNSPECIFIED SIZE 515 can select not specifying a sheet size. STANDARD SIZES 516 can select size from typical sheet sizes available in the market. USER-SET SIZE 517 can set the sheet's width and length with specific numerical values. ENVELOPE 518 and POSTCARD 519 can select envelope size and postcard size, respectively, in particular out of the typical sheet sizes available in the market.

On a sheet size selection screen 511, once the input unit 303 detects pressing of AUTOMATIC DETECTION 512, the control unit 301 displays a sheet size detected by the manual feed sensor group 150 on CURRENT SHEET SIZE 513. Once the input unit 303 detects pressing of NEXT 514, the operation screen changes to a screen shown in FIG. 5C.

FIG. 5C is a screen for selecting the type of the sheet placed on the manual feed tray 151. The sheet type selected here is used as a base sheet type, and a setting value thereof is changed. There are two ways of selecting the base sheet type: selecting, by a user, one from a sheet type list 522 and selecting one using AUTOMATIC DETECTION 525. AUTOMATIC DETECTION 525 specifies a sheet type using the media sensor 401 included in the manual feed sensor group 150. On a sheet type selection screen 521, once the input unit 303 detects that, for instance, plain paper 523 is selected by a user operation, plain paper 523 is changed in color to yellow. Also, once the input unit 303 detects that AUTOMATIC DETECTION 525 is selected, AUTOMATIC DETECTION 525 is changed in color to yellow, as shown in FIG. 6A. Also, information on preset setting values set for the base sheet type selected from the sheet type list 522 can be checked on DETAILED INFORMATION 527.

On the sheet type selection screen 521, once the input unit 303 detects pressing of NEXT 526, the control unit 301 determines whether the sheet size selected in FIG. 5B and the base sheet type selected in FIG. 5C are adjustable using the scanner. The scanner in the present embodiment is the reader section 139 and is used as a means for reading a chart image for adjustment printed on an original. The scanner has two reading means: one that reads the chart using the original conveyance unit 136 (hereinafter referred to as an automatic document feeder (ADF)) and one that directly reads the chart using the scanner unit 138 (hereinafter referred to as a platen glass). Depending on the size or type thereof, some sheets can be read using both of the ADF and the platen glass, some can be read only using the platen glass, and some can be read using neither of them. Thus, which reading means to use is automatically determined based on the size and type of the sheet, and a screen to be displayed is switched accordingly.

In a case where the control unit 301 determines that the sheet is scannable using either the ADF or the platen glass, the operation screen changes to the screen shown in FIG. 5D. In a case where the control unit 301 determines that the sheet is scannable using neither the ADF nor the platen glass, the selected sheet size and base sheet type are set for the manual feed tray 151, and the operation screen changes back to the screen shown in FIG. 5A. On this screen, the sheet size and sheet type set for the manual feed tray 151 are displayed on sheet size 503 and sheet type 504 in FIG. 5A.

FIG. 5D is a screen for outputting an adjustment chart for changing a setting value based on the setting of the sheet size selected in FIG. 5B and the setting of the base sheet type selected in FIG. 5C. Once the input unit 303 detects pressing of START PRINT 532 on an adjustment print screen 531, the control unit 301 determines whether a sheet with the size and type being set is scannable using the ADF. In a case where it is determined that the sheet is scannable using the ADF, the control unit 301 instructs the printer control unit 306 to print an adjustment chart for the ADF, and then the operation screen changes to the screen shown in FIG. 5E. In a case where it is determined that the sheet is not scannable using the ADF, the control unit 301 instructs the printer control unit 306 to print an adjustment chart for the platen glass, and then the operation screen changes to the screen shown in FIG. 5F.

FIG. 5E is a screen for reading an adjustment chart using the ADF. Once the input unit 303 detects that an adjustment chart is loaded into the original conveyance unit 136 as instructed on the display and that START READ 542 has been pressed on an ADF read screen 541, the control unit 301 issues a read instruction to the scanner control unit 307. The control unit 301 receives, from the scanner control unit 307, a result of measurement of an adjustment value obtained from a read result, and saves it in the sheet information management unit 304. After that, the operation screen changes to the screen shown in FIG. 5G. Note that examples of the adjustment value measured in this processing include an adjustment value for transfer voltage (an adjustment value for making a minor adjustment of voltage for toner transfer) and an adjustment value for a print position (an adjustment value for making a minor adjustment of a position at which to print an image).

FIG. 5F is a screen for reading an adjustment chart using the platen glass. Once the input unit 303 detects that an adjustment chart is loaded in the scanner unit 138 as instructed on the display and that START READ 552 is pressed on a platen glass read screen 551, the control unit 301 issues a read instruction to the scanner control unit 307. The control unit 301 receives, from the scanner control unit 307, a result of measurement of an adjustment value obtained from a read result, and saves it in the sheet information management unit 304. After that, the operation screen changes to the screen shown in FIG. 5G.

FIG. 5G is a screen for naming the new user-set sheet saved in the sheet information management unit 304. The name decided here will be displayed on the sheet type selection screen the next time the user loads the same sheet into the paper feed unit 148. Once the input unit 303 detects pressing of NAME 562 on a name input screen 561, the control unit 301 displays the screen shown in FIG. 5H. Once the input unit 303 detects pressing of an OK button 572 on a keyboard screen 571, the name is saved, overwriting the existing one, and the screen returns to the name input screen 561. Once the input unit 303 detects pressing of CANCEL 573, no name is saved to overwrite the existing one, and the screen returns to the name input screen 561. Once the input unit 303 detects pressing of an OK button 563 on the name input screen 561, the control unit 301 sets the selected sheet size and the new user-set sheet for the manual feed tray 151, and the operation screen returns to the screen shown in FIG. 5A. On this screen, the sheet size and the sheet type set for the manual feed tray 151 are displayed on sheet size 503 and sheet type 504 in FIG. 5A, respectively.

FIGS. 6A to 6C are diagrams showing an example of display screens displayed in a case where automatic detection is used to determine the sheet type in the user sheet registration processing described using FIGS. 5A to 5H. FIG. 6A is a screen displayed on the display unit 302 upon pressing of AUTOMATIC DETECTION 525 in FIG. 5C. Once the input unit 303 detects pressing of NEXT 602 on a sheet type selection screen 601, the operation screen changes to the screen shown in FIG. 6B.

FIG. 6B is a screen for outputting an adjustment chart, like in FIG. 5D. Once the input unit 303 detects pressing of START PRINT 612 on an adjustment print screen 611, the control unit 301 determines whether AUTOMATIC DETECTION 525 has been selected on the sheet type selection screen 601. In a case where AUTOMATIC DETECTION 525 has been selected, the control unit 301 issues a print instruction to the printer control unit 306 to detect the type of the sheet being fed, using the media sensor 401. The control unit 301 obtains the detection result of the sheet type from the media sensor control unit 305 and sets the obtained sheet type as a base sheet type.

Also, the control unit 301 determines whether a sheet with the base sheet type is scannable using the ADF or the platen glass. In a case where the control unit 301 determines that the sheet is scannable using neither the ADF nor the platen glass, the display unit 302 changes the operation screen to the screen shown in FIG. 6C.

FIG. 6C is an example of a pop-up screen presented in a case where the sheet type determined based on the detection result obtained by the media sensor 401 is not an automatically adjustable sheet. Once the input unit 303 detects pressing of an OK button 622 on a pop-up screen 621, the selected sheet size and base sheet type are set for the manual feed tray 151, and the screen returns to the screen shown in FIG. 5A. On this screen, the sheet type determined based on the detection result obtained by the media sensor 401 is set as the base sheet type, and the sheet size and the sheet type set for the manual feed tray 151 are displayed on sheet size 503 and sheet type 504, respectively.

### <Flowchart>

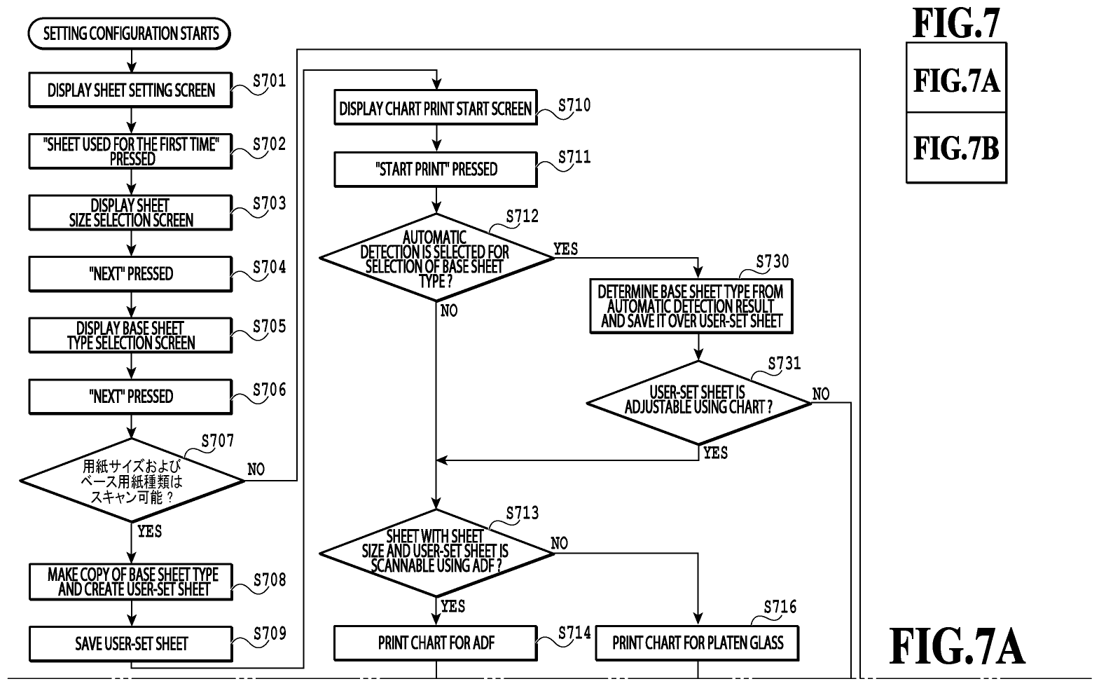

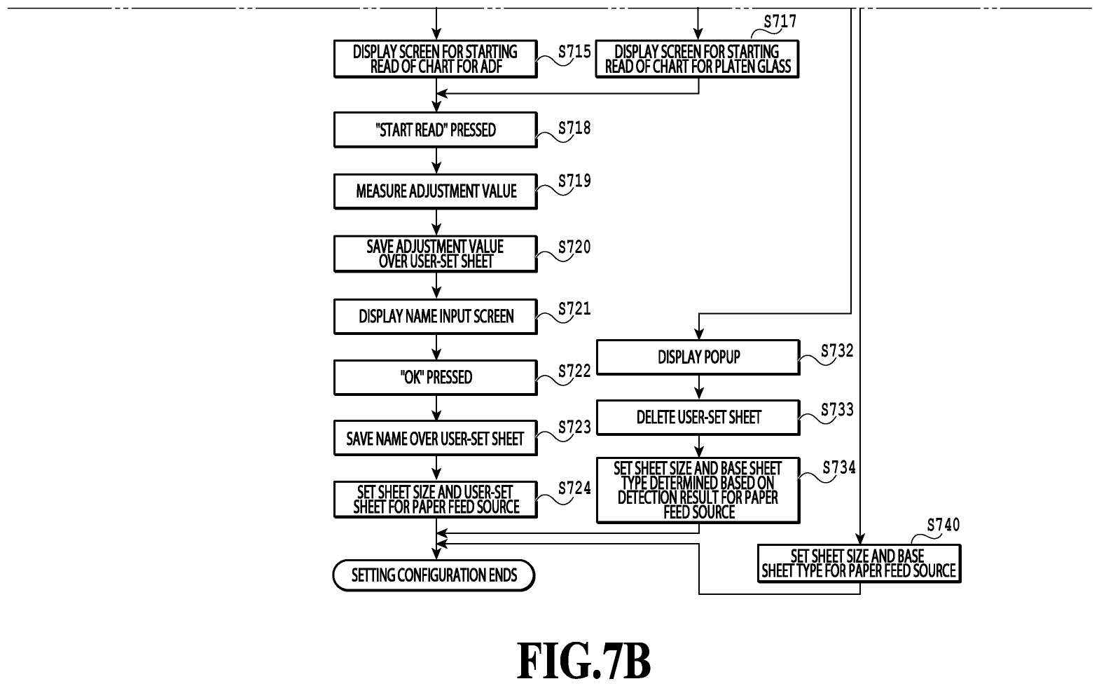

FIGS. 7A and 7B are flowcharts showing processing performed in the present embodiment to determine a means for changing a setting value according to a sheet size and a base sheet type, associate the setting value changed using the determined changing means with a user-set sheet, and registers them into the sheet information management unit 304. Firmware for the processing of this flowchart is stored in the HDD 204 of the image processing apparatus 100, is loaded into the RAM 202, and is executed by the CPU 201. The present flowchart is started upon receipt of an operation for displaying a screen for editing a sheet size and a sheet type for a paper feed source in the paper feed unit 148.

First, in S701, the CPU 201 of the image processing apparatus 100 displays a screen for editing a sheet size and a sheet type for a paper feed source in the paper feed unit 148. Specifically, once the manual feed sensor group 150 detects that a sheet is placed on the manual feed tray 151, a screen like the one shown in FIG. 5A is displayed. Next, in S702, upon detection of pressing of SHEET USED FOR THE FIRST TIME 502 on the setting screen shown in FIG. 5A, the CPU 201 proceeds to S703. In S703, the CPU 201 displays the screen shown in FIG. 5B. In S704, upon detection of pressing of NEXT 514 on the setting screen shown in FIG. 5B, the CPU 201 proceeds to S705. In S705, the CPU 201 displays a screen like the one shown in FIG. 5C. In S706, after determining that NEXT 526 has been pressed, the CPU 201 proceeds to S707.

In S707, the CPU 201 determines whether a sheet with the selected sheet size and base sheet type is scannable using the ADF or the platen glass. If it is determined that the sheet is scannable, the CPU 201 proceeds to S708. If it is determined that the sheet is not scannable, the CPU 201 proceeds to S740. Note that if AUTOMATIC DETECTION 525 is selected in S705, a dummy setting value is allocated to the sheet so that the determination result of this step would be YES (i.e., the processing would proceed to S708). In other words, if automatic detection is being selected, the CPU 201 determines “YES” in this step. In S740, the CPU 201 sets the selected sheet size and sheet type for the paper feed source. After that, the CPU 201 ends the present flowchart.

In S708, the CPU 201 makes a copy of the selected base sheet type and creates a user-set sheet. A base sheet type is what the image processing apparatus has as a default sheet type, and this base sheet type is classified as not being adjustable in its setting value. By contrast, a user-set sheet is created as a new sheet type being adjustable in its setting value, by being copied from the base sheet type. Thus, no matter how many times the setting value of the user-set sheet is changed, the original base sheet type is not affected. In S709, the CPU 201 saves the created user-set sheet in the sheet information management unit 304. Note that in a case where AUTOMATIC DETECTION 525 is selected in S705, the user-set sheet is created in this step using a dummy setting value. However, as will be described later, in a later step in the flowchart, processing is performed to delete or update the adjustment value of the user-set sheet created using a dummy setting value. Thus, a user-set sheet using a dummy set value will never be printed. Next, in S710, the CPU 201 displays a screen like the one shown in FIG. 5D. In S711, upon detection of pressing of START PRINT 532, the CPU 201 proceeds to S712.

In S712, the CPU 201 determines whether the selected base sheet type has been selected using automatic detection. If it is determined that the selected base sheet type has been selected using automatic detection, the CPU 201 proceeds to S730. If it is determined that the selected base sheet type has not been selected by automatic detection, the CPU 201 proceeds to S713.

In S730, the CPU 201 determines the base sheet type based on a detection result obtained using the media sensor 401 and saves the base sheet type, overwriting the user-set sheet saved in the sheet information management unit 304. In S731, the CPU 201 determines whether the user-set sheet is scannable using the ADF or the platen glass. If it is determined that the user-set sheet is scannable, the CPU 201 proceeds to S713. Meanwhile, if it is determined that the user-set sheet is not scannable, the CPU 201 proceeds to S732. In S713, the CPU 201 determines whether a sheet with the selected sheet size and user-set sheet is scannable using the ADF. If it is determined that the sheet is scannable using the ADF, the CPU 201 proceeds to S714. If it is determined that the sheet is not scannable using the ADF, the CPU 201 proceeds to S716.

In S714, the CPU 201 prints a chart for the ADF. In S715, the CPU 201 displays a screen like the one in FIG. 5E and proceeds to S718.

In S716, the CPU 201 prints a chart for the platen glass. In S717, the CPU 201 displays a screen like the one in FIG. 5F and proceeds to S718.

In S718, if it is determined that START READ 542 or START READ 552 has been pressed, the CPU 201 proceeds to S719. In S719, the CPU 201 reads the adjustment chart and measures an adjustment value. In S720, the CPU 201 saves the measured adjustment value, overwriting the user-set sheet saved in the sheet information management unit 304. In S721, the CPU 201 displays a user-set sheet registration screen like the one in FIG. 5G. In S722, upon detection of pressing of OK 563, the CPU 201 proceeds to S723.

In S723, the CPU 201 saves the inputted name, overwriting the user-set sheet saved in the sheet information management unit 304. In S724, the CPU 201 sets the selected sheet size and the user-set sheet for the paper feed source. After that, the CPU 201 ends the processing of the present flowchart.

Going back to a description for a case where the CPU 201 determines “NO” in S731, in S732 the CPU 201 displays a pop-up screen like the one in FIG. 6C. In S733, the CPU 201 deletes the user-set sheet saved in the DB. In S734, the CPU 201 sets, for the paper feed source, the selected sheet size and the base sheet type determined using the media sensor. After that, the CPU 201 ends the processing of the present flowchart.

As thus described, the present embodiment can improve convenience in configuring print settings. Specifically, it is determined based on the sheet fed to the paper feed source whether to configure print setting values manually or automatically using a chart. In either way, all what a user needs to do is to perform a series of operations according to the procedure displayed on the operation unit, and this eliminates the need for the user to decide and adjust setting values.

### OTHER EMBODIMENTS

After the image processing apparatus 100 measures an adjustment value and overwrites the user-set sheet in S719 in FIG. 7, the user may further be allowed to change the setting value.

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-104094, filed Jun. 26, 2023, which is hereby incorporated by reference wherein in its entirety.

What is claimed is:

1. An image processing apparatus comprising at least one memory and at least one processor which function as
an identification unit that identifies a sheet size and a sheet type of an adjustment target sheet,
a display control unit that, in a case of making an adjustment of a setting value of the sheet type automatically based on the sheet size and the sheet type identified by the identification unit, displays on a display unit an operating procedure for making the adjustment automatically, and
a setting unit that sets the sheet size and the sheet type after the adjustment for a paper feed source into which the adjustment target sheet is loaded.

2. The image processing apparatus according to claim 1, wherein
the at least one memory and the at least one processor further function as a determination unit that determines, based on the sheet size and the sheet type identified by the identification unit, whether to make the adjustment of the setting value of the sheet type automatically, and
in a case where the determination unit determines to make the adjustment automatically, the display control unit displays on the display unit the operating procedure for making the adjustment automatically.

3. The image processing apparatus according to claim 2, wherein
the identification unit identifies the sheet size and the sheet type by either automatic detection using a sensor that the paper feed source includes or reception of a selection operation performed by a user.

4. The image processing apparatus according to claim 3, wherein
the at least one memory and the at least one processor further function as a creation unit that, after the determination unit determines to make the adjustment of the setting value of the sheet type automatically, creates, from the sheet type identified by the identification unit, a user-set sheet as a new sheet type, the user-set sheet being adjustable in the setting value.

5. The image processing apparatus according to claim 4, wherein
the setting unit makes the adjustment of the setting value automatically by printing a chart for adjustment corresponding to the sheet size and the sheet type identified by the identification unit and reading the chart using an automatic document feeder or a platen glass.

6. The image processing apparatus according to claim 4, wherein
the setting unit further updates the setting value of the user-set sheet to the adjusted setting value and registers the user-set sheet into a database.

7. The image processing apparatus according to claim 3, wherein
in a case where the determination unit determines not to make the adjustment automatically, the setting unit sets, for the paper feed source, the sheet size and the sheet type identified by the identification unit.

8. The image processing apparatus according to claim 4, wherein
in a case where the sheet type identified using the automatic detection is a sheet type for which it is not possible to make the adjustment of the setting value automatically, the display control unit displays an indication that the adjustment of the setting value is not possible.

9. The image processing apparatus according to claim 8, wherein
in a case where the sheet type identified by the automatic detection is a sheet type for which it is not possible to make the adjustment of the setting value automatically, the setting unit deletes the user-set sheet created by the creation unit and sets, for the paper feed source, the sheet size and the sheet type identified by the identification unit.

10. The image processing apparatus according to claim 1, wherein
the setting value includes a value of transfer voltage or a value indicative of a print position.

11. The image processing apparatus according to claim 1, wherein
the adjustment target sheet is a sheet used for a first time in the image processing apparatus.

12. A method for controlling an image processing apparatus, the method comprising:
identifying a sheet size and a sheet type of an adjustment target sheet;
in a case of making an adjustment of a setting value of the sheet type automatically based on the sheet size and the sheet type identified in the identifying, displaying on a display unit an operating procedure for making the adjustment automatically; and
setting the sheet size and the sheet type after the adjustment for a paper feed source into which the adjustment target sheet is loaded.

13. A non-transitory computer readable storage medium storing a program which functions in an image processing apparatus and causes the image processing apparatus to function as
an identification unit that identifies a sheet size and a sheet type of an adjustment target sheet,
a display control unit that, in a case of making an adjustment of a setting value of the sheet type automatically based on the sheet size and the sheet type identified by the identification unit, displays on a display unit an operating procedure for making the adjustment automatically, and
a setting unit that sets the sheet size and the sheet type after the adjustment for a paper feed source into which the adjustment target sheet is loaded.
